(19) United States
(12) Patent Application Publication
(10) Pub. No.: US 2009/0233541 A1
(43) Pub. Date: Sep. 17, 2009

(54) MOLDING PROCESS FOR RIDGE VENTS AND OTHER INDEX MOLDED PRODUCTS

(75) Inventors: Robert Bradley Holland, Rowlett, TX (US); Phillip R. Grisham, Dallas, TX (US)

Correspondence Address: DUANE MORRIS LLP - Philadelphia;IP DEPARTMENT, 30 SOUTH 17TH STREET, PHILADELPHIA, PA, 19103-4196, US

(73) Assignee: AIR VENT, INC., Dallas, TX (US)

(21) Appl. No.: 12/047,064

(22) Filed: Mar. 12, 2008

(51) Int. Cl. F24F 7/02; B28B 7/18

(52) U.S. Cl. 454/365; 264/255

(57) ABSTRACT

A method of making a ridge vent includes: disposing a first quantity of a polymeric material in a mold cavity; forming a first ridge vent section in the mold cavity, the first ridge vent section having a stepped end section formed across a width of the first ridge vent section at an end thereof; indexing the first ridge vent section so that it is substantially moved beyond the mold cavity but remains in contact at the stepped end section with the mold; disposing a second quantity of polymer between the mold sections; and forming a second ridge vent section which is connected to the first ridge vent section at the stepped end section. The stepped end section includes bottom tread and top tread sections, wherein the tread length of the bottom tread section has a non-uniform tread length across the width of the bottom tread section.

### FIELD OF THE INVENTION

The present invention relates to molding processes and more particularly to index molding processes.

### BACKGROUND OF THE INVENTION

Index injection and compression molding processes are described in commonly assigned U.S. Pat. Nos. 6,881,144 and 6,991,535 to Ciepliski et al. (the “'144 and '535 Patents”), which are both hereby incorporated by reference herein. More specifically, these patents describe an index molding process for use in forming rollable plastic ridge vents. As described in those patents and illustrated in FIGS. 1 and 2 herein (reprinted from FIGS. 9 and 10 of the '535 Patent), a mold 102 having upper and lower mold sections, shown in phantom in FIG. 1, is provided for forming a mold cavity. A quantity of polymeric material is disposed in the mold cavity and a first ridge vent section 101, also shown in phantom, is formed in the mold cavity. Next, the first ridge vent section 101 is indexed so that it is substantially moved beyond the mold cavity but remains in contact with the mold 102. As shown in FIG. 2, a small stepped extension formed in the baffle and central panel of the molded section 101, can remain in the mold 102. Finally, a second quantity of polymer is disposed between the mold sections of mold 102 and a second ridge vent section is formed which is connected to the first ridge vent section 101. The cooled ridge vent sections can then be rolled up in a length containing about 20 to 50 feet of vent material, which is then packaged in a paper or polyethylene wrap.

The index molding method described above has proved to be an efficient method of forming continuous lengths of rollable ridge vent. But, the process is not without its problems. As described above, the end of the indexed molded section 101 utilizes a stepped extension across the width of the panel body which is overmolded and forms a seamless connection between molded sections. The present applicant has noticed that adjacent overmold-connected sections can crack and separate in the area of this stepped section in cold environments, such as during torqueing or unrolling of a length of rolled ridge vent. While not wanting to be limited to any one theory, the applicant believes that this cracking/separation is the result of continuous stress concentration features that extend laterally across the vent at the overmold location introduced, for example, from rolling the ridge vent during packaging or bending of the product during installation. Therefore, there is a need for an improved molding process resulting in a more robust molded product.

### SUMMARY OF THE INVENTION

A method of making a ridge vent is provided including the following steps: providing a mold having upper and lower mold sections forming a mold cavity therebetween; disposing a first quantity of a polymeric material in the mold cavity between the mold sections; forming a first ridge vent section in the mold cavity, the first ridge vent section having a stepped end section formed across a width of the first ridge vent section at an end thereof; indexing the first ridge vent section so that it is substantially moved beyond the mold cavity but remains in contact at the stepped end section with the mold; disposing a second quantity of polymer between the mold sections; and forming a second ridge vent section which is connected to the first ridge vent section at the stepped end section. The stepped end section includes bottom tread and top tread sections, wherein the tread length of the bottom tread section has a non-uniform tread length across the width of the bottom tread section.

In one embodiment, the end section comprises a recessed region comprising a plurality of spaced exhaust venting holes formed therethrough and regions of increased thickness formed between adjacent ones of the spaced exhaust venting holes.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIGS. 1 and 2 illustrate a prior art index molding process;

FIG. 3 is a partial perspective view of a molded section of a rollable ridge vent for use in a prior art index molding process;

FIG. 4 is a partial perspective view of a molded section of a rollable ridge vent for use in the index molding process of the present invention;

FIG. 5 is a flow chart illustrating the molding process of the present invention;

FIG. 6 is an enlarged partial perspective view of an end section of an alternative embodiment of the molded section of FIG. 4;

FIG. 7 is an enlarged partial perspective view of an end section of another alternative embodiment of the molded section of FIG. 4;

FIG. 8 is an enlarged partial perspective view of an end section of another alternative embodiment of the molded section of FIG. 4;

FIG. 9A is a top plan view illustrating an alternative embodiment of the present invention and FIG. 9B is a enlarged partial view of a portion of FIG. 9A; and

FIG. 9C is a top plan view illustrating another alternative embodiment of the present invention.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

As used herein, “index molding” is a process whereby a first product is molded and then moved substantially outside of the mold. A portion of the first molded product is left in contact with or within the mold during molding of a second molded product, which is molded to the portion of the first product left in contact with or within the mold.

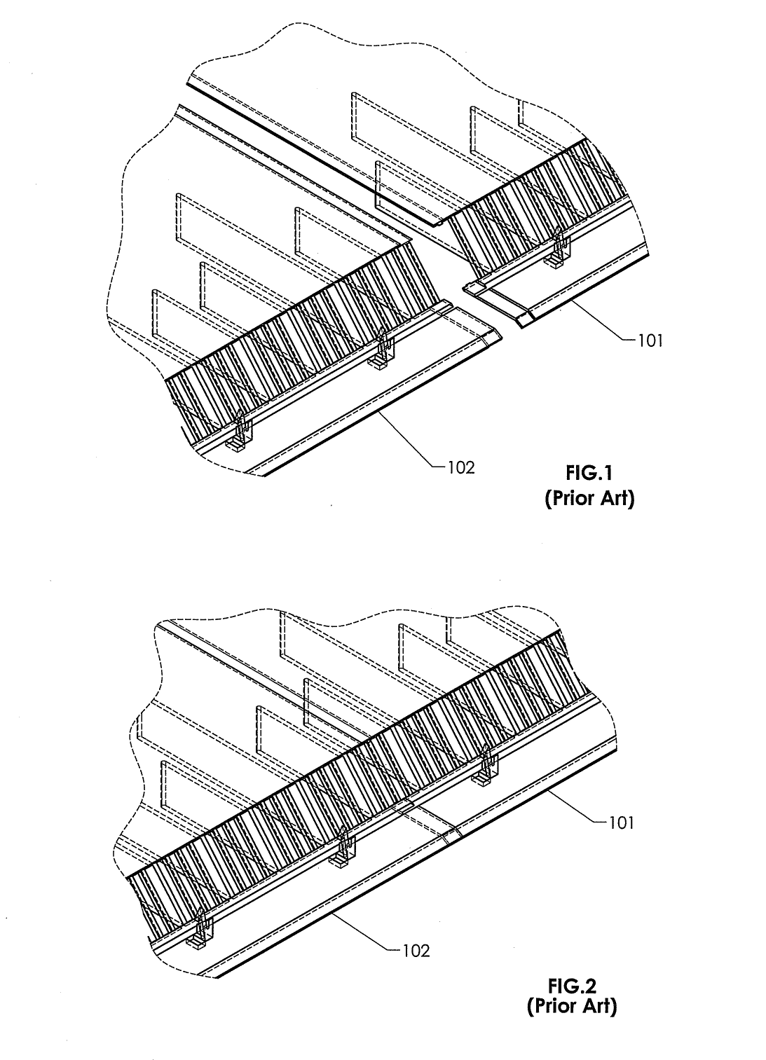

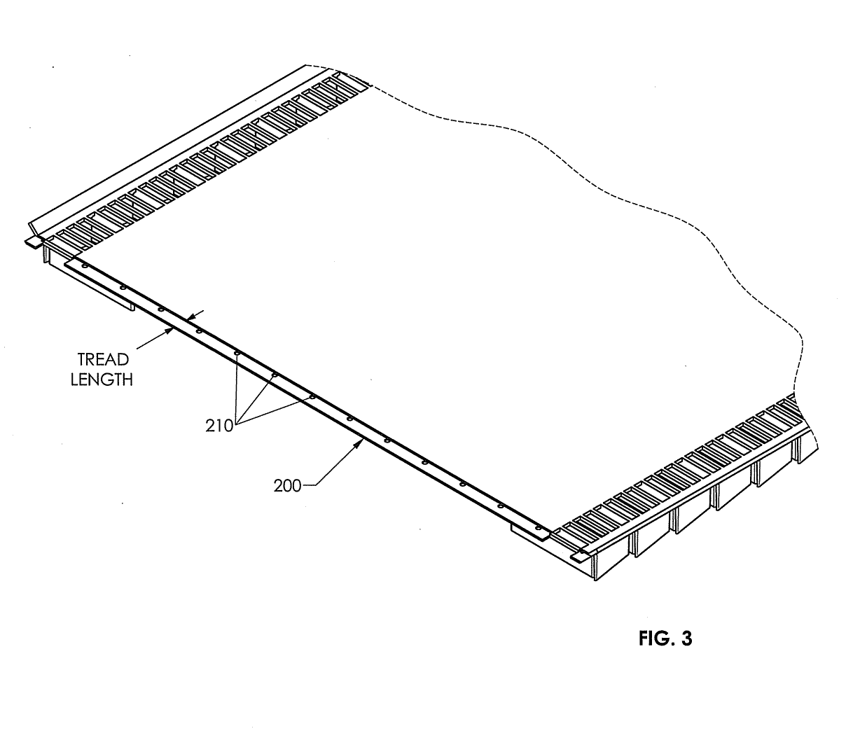

As described in the Background of the Invention section, the end of the indexed molded section 101 has a stepped extension formed across the width of the panel body. This stepped extension remains in or is placed in the mold after the first section is molded and is then overmolded upon formation of the next molded section, forming a seamless connection between the two molded sections and a continuous molded product. An example of this stepped section (identified by reference number 200) is shown in the partial perspective view of FIG. 3, which shows a molded ridge vent section similar to that shown in FIG. 1 of commonly assigned U.S. patent application Ser. No. 11/238,315 (hereinafter, the “'315 Patent Application”), published as U.S. Patent Publication No. 2007/0072540, the entirety of which is hereby incorporated by reference herein. Applicant has learned that ridge vents formed using the index injection molding process described above are prone to cracking or separation in the area of the stepped section 200, particularly in cold temperatures. The previous design includes continuous geometric stress concentration features at the overmold seam that make the product substantially weaker at these locations compared to other locations down the length of the vent. In this design, cracking propagates from the stepped seam feature at the overmold section. Fracturing has been observed at the step near the riser wall on the top surface and at the very end of the vent (furthest outboard section of the tread) on the underside of the vent, depending on the direction of the bending moment applied to the vent.

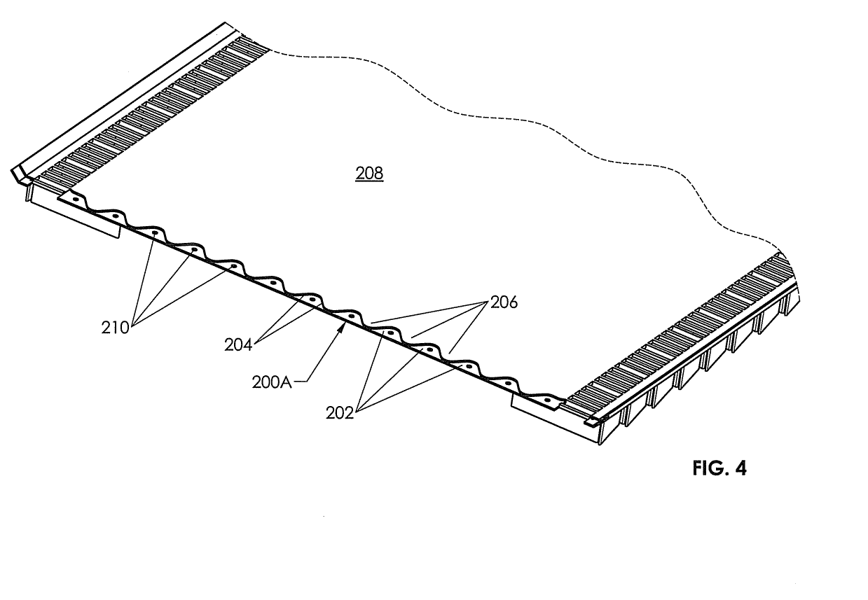

An exemplary process for forming a rollable ridge vent, such as that described in the '144 and '535 Patents or in the '315 Patent Application is described hereafter in connection with FIGS. 4-7. Turning first to FIG. 4, FIG. 4 is a partial perspective view of a molded section of a rollable ridge vent for use in the index molding process described above in connection with FIGS. 1 and 2 and hereafter. The ridge vent section is identical in all respect to the ridge vent section shown in FIG. 3 and described in the '315 Patent Application except for the configuration of the stepped end section 200A at the end of the ridge vent section. It should be understood that FIG. 4 illustrates an intermediate product (like molded section 101 of FIGS. 1 and 2) that is used in forming a longer length of rollable ridge vent. With reference to terms commonly used to identify step components, the stepped end section 200A includes a bottom tread section 202, a riser wall 204 and a top tread section 206. The top tread section 206, which is essentially the top surface of the central panel portion 208 of the ridge vent section, is connected to the bottom tread section 202 by the riser wall 204. The bottom tread section 202 can also be viewed as a recess in the central panel 208 or a region of less thickness when compared to top tread section 206.

Returning to FIG. 3, it can seen that the tread length (also known as “tread depth”), defined as the distance between the edge of the tread and the riser wall, of the bottom tread section is uniform across the width of the central panel of the ridge vent. In contrast, with respect to the embodiment of FIG. 4, the tread length is non-uniform across the width of the central panel 208 and tread section 202. Specifically, the tread length of the bottom tread section 202 varies in a wave pattern. In the illustrated embodiment, the wave pattern locally interposes the top tread section 206 in between adjacent exhaust venting holes 210 (which may be a contributing factor to the cracking noted above with the prior design) used during the molding process in the illustrated embodiment, though this specific location with respect to the venting holes is not a requirement of the invention. In this manner, the top tread section 206 forms a joint or seam with a second ridge vent that is interrupted (i.e., not straight) when a second ridge vent section overmolds the bottom tread section 202 of the ridge vent section of FIG. 4. It is believed that the portions of the second tread section 206 that are interposed between the spaced exhaust venting holes 210 provide undulating or interrupting features that eliminate the continuous, linear stress concentration feature of the previous design shown in FIG. 3. These undulating or interrupting features operated to deter or stop the propagation of cracks formed at the overmold location.

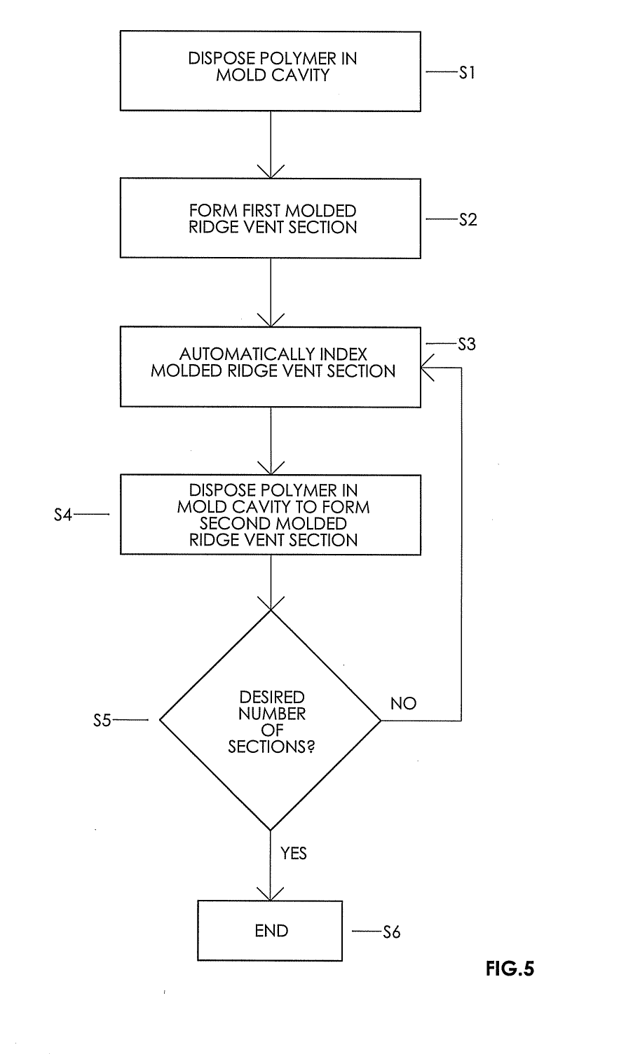

An exemplary molding process using the ridge vent section of FIG. 4 is described in connection with the flow chart of FIG. 5. The preferred index molding process of the present invention is an injection molding process, though the index process may be used with compression, extrusion or other molding processes. At step S1, a selected polymer material is disposed in a mold cavity of a mold. As will be understood from FIGS. 1 and 2 and the description of the '144 and '535 Patents, the mold includes upper and lower mold sections that define a mold cavity therebetween. The mold cavity defines the shape (in negative form) of the mold section shown in FIG. 4, including its end section 200A.

At step S2, a first molded ridge vent section (such as shown in FIG. 4) is formed in the mold. As those familiar with the art of molding will understand, molded products are formed in molds by controlling process parameters such as injection speed, material, mold temperature and pressure.

At step S3, the mold sections are opened and the so-formed first molded ridge vent section is ejected or indexed, leaving the end shown in FIG. 4 in contact with the mold. More specifically, the stepped section 200A is left in contact with the mold so that the bottom tread 202 can be overmolded during the formation of the next molded section in the mold. This step, as well as others, is preferably automated.

At step S4, the mold sections are closed and a second amount of polymer is disposed in the mold cavity to form a second molded ridge vent section, in the manner described above in connection with steps S1 and S2. This second ridge vent section has an end that is overmolded with the stepped section 200A of the first mold section, forming a continuous length of ridge vent.

If the desired number of molded sections have been formed and molded together (step S5), then the process ends at step S6, i.e., the mold is opened and the product is removed for later processing (e.g., rolling and packaging). If one or more additional sections are required, then the process returns to step S3 to index the second molded section so that a third molded section can be formed and connected to the stepped end of the second molded section. Of course, the product can be run continuously and cut to length outside of the mold (downstream of the overmolding process) while manufacturing continues.

A rollable ridge vent was formed using the process of FIG. 5 and using the stepped end section design having a non-uniform tread length shown in FIG. 4. This rollable ridge vent was tested. The tests revealed excellent results even at temperatures as low as negative 20° C. Overmolded samples of the ridge vent product were conditioned to temperatures below freezing for a period of at least 24 hours. The samples were then subjected to bending and reverse bending loads. Stress marks and crack propagation were noted for samples of the designs illustrated in FIGS. 3 and 4. The design incorporating the undulating or sinusoidal tread feature of FIG. 4 performed substantially better than the tread feature of FIG. 3. Cracking did not propagate along the length of the overmold seam for this new design.

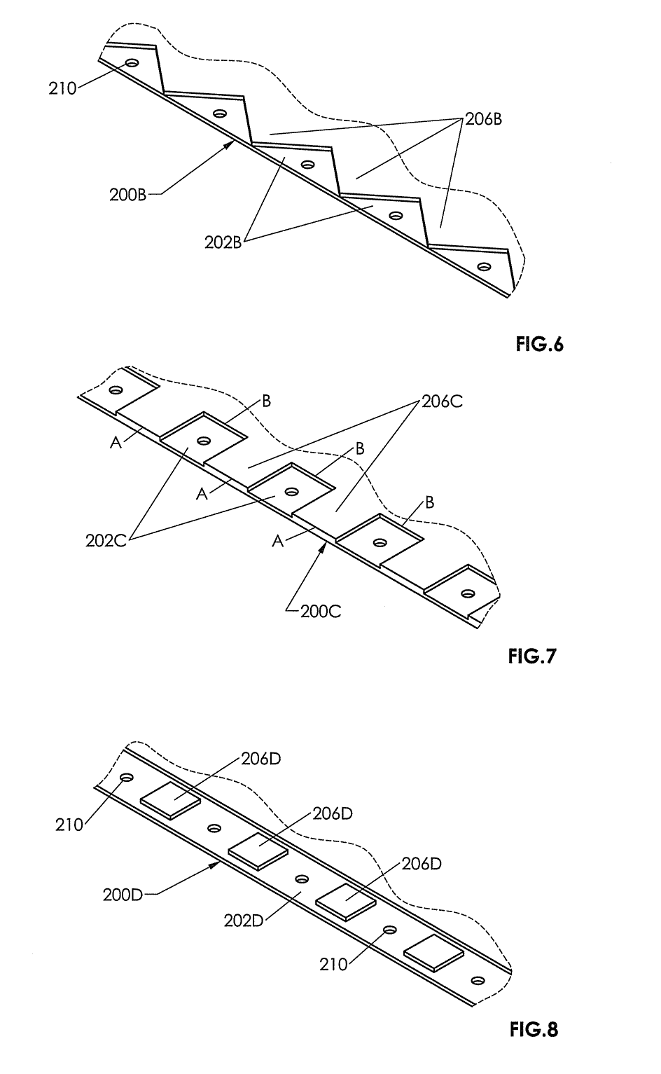

Although a wave or sinusoidal edge pattern for the treads is shown in FIG. 4, other patterns may be used that result in a non-uniform tread depth. For example, FIG. 6 shows an enlarged partial perspective view of an end section of an alternative embodiment of the molded rollable ridge vent section of FIG. 4. FIG. 6 shows an end section where the step section 200B has a sawtooth shape formed from bottom tread section 202B and top tread section 206B. The top tread section 206B extends towards the edge of the ridge vent section to separate the spaced exhaust venting holes 210.

By way of another example, FIG. 7 shows an enlarged partial perspective view of an end section of another alternative embodiment of the molded rollable ridge vent section of FIG. 4. FIG. 7 shows an end section where the step section 200C has a rectangular serrated shape formed from bottom tread section 202C and top tread section 206C. In this embodiment, the tread length/depth of the bottom tread section 202C is non-uniform in so much as it has zero or no length at, for example, points A and a different length at, for example, points B. The top tread section 206B extends towards the edge of the ridge vent section to separate the spaced exhaust venting holes 210.

Although FIGS. 4, 6 and 7 show tread patterns having periodic shapes, this is not a requirement. Non regular patterns can be selected as long as some interference is presented along the length of the overmold seam. Further, an alternative way to view the stepped end section is not by way of tread length, but rather by way of thickness of the panel section 208. In embodiments, the panel 208 is designed such at least some areas, such as areas formed between exhaust venting holes, are thicker than the areas that are recessed for being overmolded during the formation of a second molded section. For example, as shown in FIG. 8, the end section 200D can include interference islands 206D formed between exhaust venting holes within bottom tread section 202D. This embodiment can increase the amount of recessed area in the end section that can receive polymer during the formation of the second molded section, thereby improving the overmold connection between two sections. Further, in the embodiments shown in FIGS. 4, 6 and 7, the top tread sections 206, 206B and 206C need not extend all the way to the end edge of the ridge section.

The panel disclosed herein is preferably formed from relatively high impact (non-brittle) polymer materials, such as, by way of example only, polypropylene or polyethylene.

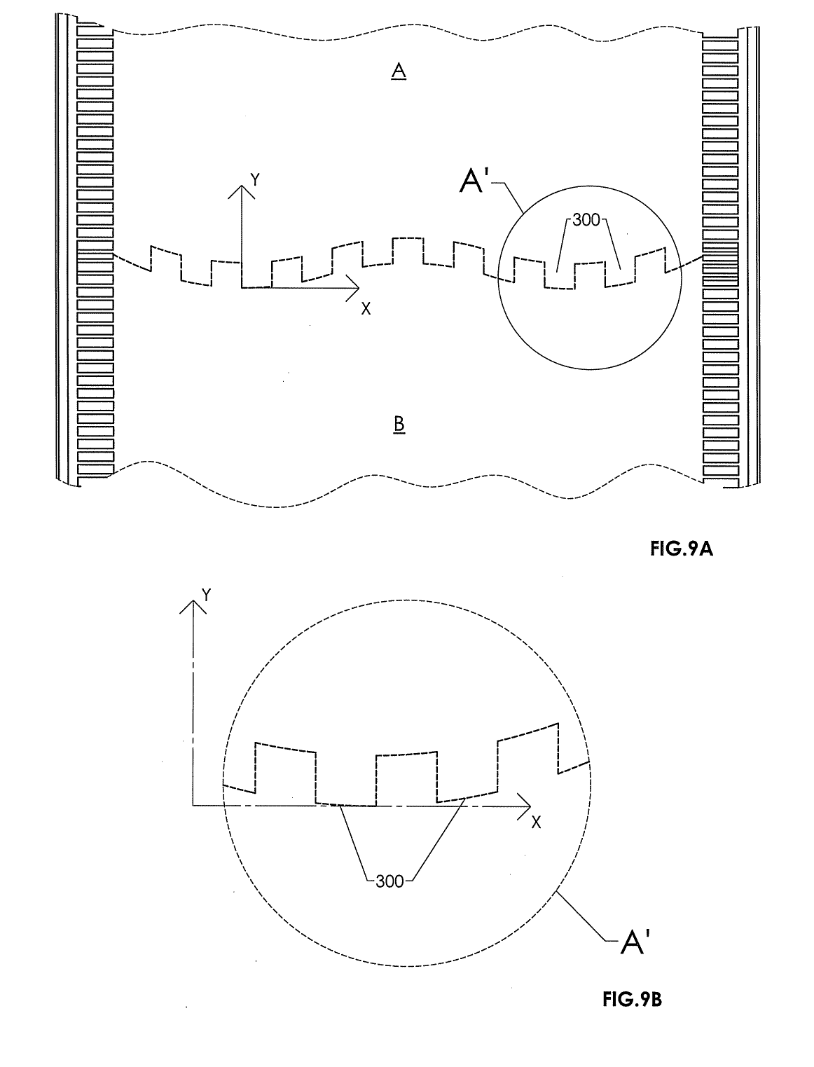

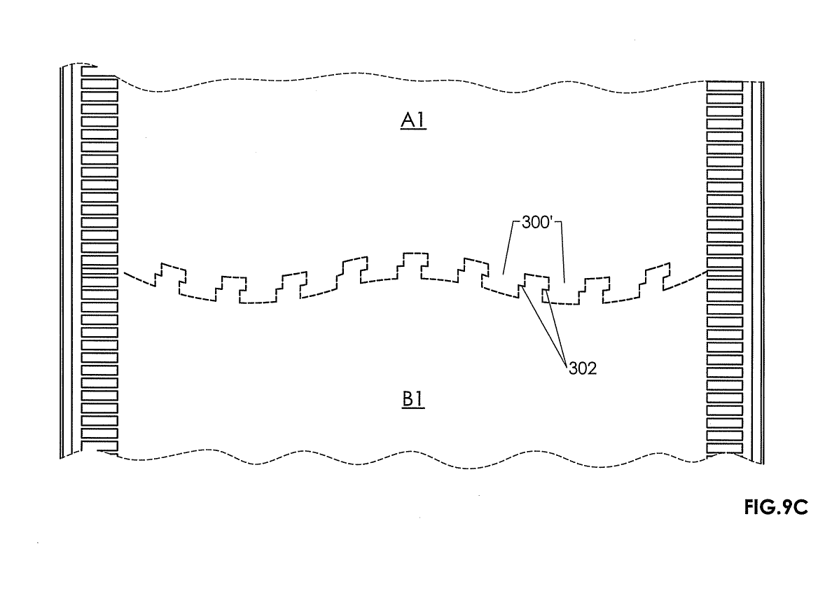

FIG. 9A is a top plan view of an alternative embodiment of a rollable ridge vent with the molded seam joining two sections A and B shown in dashed line. FIG. 9B is an enlarged partial view showing only a portion A′ of section A. The seam is shown in dashed form because the vent sections are already molded together as described above in connection with FIG. 5. That is, section A is first formed in the manner shown in FIG. 5 and then indexed, after which the mold cavity is again filled with polymer to form a second section B that is molded to (not necessarily overmolded on) the end of the first section A. FIG. 9B is an enlarged portion A′ of vent section A from FIG. 9A illustrating a portion of the end of section A prior to being molded to subsequently formed section B. As shown in both FIGS. 9A and 9B, the end of section A need not have a ledge that is overmolded by the polymer in forming the second section B. In this embodiment, the edge takes a non-straight (zig-zag or notched) shape, such as a dovetail shape comprising teeth 300. The edge is made discontinuous in the X-direction across the width of the vent section. Alternatively, or in addition thereto, the distance in the Y-direction of the edge from a given reference line perpendicular to the Y-direction (e.g., the X-axis) varies, such as in the sinusoidal manner best illustrated in FIG. 9A. As with the embodiments of FIGS. 4 and 6-8, the discontinuities of the edge shape help to prevent the propagation of cracks and fractures along the mold seam similar to the embodiments described above in connection with FIGS. 4, 6, 7 and 8. Put another way, the notched edge prevents the formation of a continuous straight seam between sections A and B that is prone to crack and fracture propagation.

Another embodiment is shown in FIG. 9C. This embodiment is similar to the embodiment shown in FIG. 9A only additional discontinuities are provided in the teeth 300′ of the edge of section A in the form of lateral steps 302 formed in the Y-direction.

Although the invention has been described in terms of exemplary embodiments, it is not limited thereto. For example, although the improved configurations are described for use with forming lengths of rollable ridge vent, these configurations could also be used in the formation of other index molded products where it is desired to improve the bond between sections molded together. The appended claims should be construed broadly to include other variants and embodiments of the invention that may be made by those skilled in the art without departing from the scope and range of equivalents of the invention.

What is claimed is:

1. A method of making a ridge vent, comprising:
providing a mold having upper and lower mold sections forming a mold cavity therebetween;
disposing a first quantity of a polymeric material in said mold cavity between said mold sections;
forming a first ridge vent section in said mold cavity, said first ridge vent section having a stepped end section formed across a width of said first ridge vent section at an end thereof;
indexing said first ridge vent section so that it is substantially moved beyond said mold cavity but remains in contact at said stepped end section with said mold;
disposing a second quantity of polymer between said mold sections; and
forming a second ridge vent section which is connected to said first ridge vent section at said stepped end section,
wherein said stepped end section comprises bottom tread and top tread sections, wherein the tread length of said bottom tread section has a non-uniform tread length across the width of said bottom tread section.

2. The method of claim 1, wherein said first ridge vent section is automatically indexed forward prior to forming said second ridge vent section.

3. The method of claim 2, wherein said mold sections open and close between forming said first ridge vent section and said second ridge vent section.

4. The method of claim 1, wherein said disposing steps comprise injection molding.

5. The method of claim 1, wherein said bottom tread section has a plurality of spaced exhaust venting holes formed therethrough, wherein said top tread section includes regions formed in between at least some of said spaced exhaust venting holes.

6. The method of claim 1, wherein said non-uniform tread length has a wave pattern.

7. The method of claim 1, wherein said non-uniform tread length has a sawtooth pattern.

8. The method of claim 1, wherein said non-uniform tread length has a rectangular serrated pattern.

9. A rollable ridge vent comprising a central panel having a stepped end section formed across a width of said central panel at an end thereof, wherein said stepped end section comprises a bottom tread and top tread sections, wherein the tread length of said bottom tread section has a non-uniform tread length across the width of said bottom tread section.

10. The rollable ridge vent of claim 9, wherein said bottom tread section has a plurality of spaced exhaust venting holes formed therethrough, wherein said top tread section includes regions formed in between at least some of said spaced exhaust venting holes.

11. The rollable ridge vent of claim 10, wherein said non-uniform tread length forms a wave pattern.

12. The rollable ridge vent of claim 10, wherein said non-uniform tread length forms a sawtooth pattern.

13. The rollable ridge vent of claim 10, wherein said non-uniform tread length forms a rectangular serrated pattern.

14. A method of making a ridge vent, comprising:
providing a mold having upper and lower mold sections forming a mold cavity therebetween;
disposing a first quantity of a polymeric material in said mold cavity between said mold sections;
forming a first ridge vent section in said mold cavity, said first ridge vent section having an end section formed across a width of said first ridge vent section at an end thereof; indexing said first ridge vent section so that it is substantially moved beyond said mold cavity but remains in contact at said end section with said mold;
disposing a second quantity of polymer between said mold sections; and
forming a second ridge vent section which is connected to said first ridge vent section at said end section,
wherein said end section comprises a recessed region comprising a plurality of spaced exhaust venting holes formed therethrough and regions of increased thickness formed between adjacent ones of said spaced exhaust venting holes.

15. The method of claim 14, wherein said first ridge vent section is automatically indexed forward prior to forming said second ridge vent section.

16. The method of claim 15, wherein said mold sections open and close between forming said first ridge vent section and said second ridge vent section.

17. The method of claim 14, wherein said disposing steps comprise injection molding.

18. The method of claim 14, wherein said end section comprises bottom tread and top tread sections, said top tread section forming said regions of increased thickness, wherein the tread length of said bottom tread section has a non-uniform tread length across the width of said bottom tread section.

19. The method of claim 14, wherein said regions of increased thickness comprises islands within said recessed region.
